(19) United States
(12) Patent Application Publication
(10) Pub. No.: US 2024/0315208 A1
(43) Pub. Date: Sep. 26, 2024

(54) Hands-Free Leash Assembly

(71) Applicant: Dustin M. Scabarozi, Merritt Island, FL (US)

(72) Inventor: Dustin M. Scabarozi, Merritt Island, FL (US)

(73) Assignee: Dustin M. Scabarozi, Merritt Island, FL (US)

(21) Appl. No.: 18/614,704

(22) Filed: Mar. 25, 2024

Related U.S. Application Data
(60) Provisional application No. 63/454,652, filed on Mar. 25, 2023.

(51) Int. Cl. A01K 27/00

(52) U.S. Cl. CPC A01K 27/005

(57) ABSTRACT

An apparatus for walking a companion animal, the apparatus comprising a first coupling portion at a distal end; and a second coupling portion at a proximal end, wherein the first coupling portion comprises a first upward-facing well configured to receive a leash, and the second coupling portion comprises a second downward-facing well configured to receive a belt or a clothing portion of a person. An apparatus allows for a person to walk a dog, or multiple dogs, hands-free, and may allow for a person to quickly release it, and/or quickly release a leash from the apparatus.

The disclosure is directed to an apparatus configured for one to walk a companion animal on a leash “hands-free”.

### BACKGROUND

Companion animals, for example dogs, generally require walking. People often carry a cell phone, a beverage, a bag to collect dog waste, etc. Desired is an apparatus configured to couple to a dog leash to allow one to walk a dog hands-free. Also desired is an apparatus configured to couple to a leash that would allow for one to quickly release the apparatus in case an animal is pulling too hard or if one otherwise desires to quickly release the animal.

### SUMMARY

According, disclosed is an apparatus for walking a companion animal, the apparatus comprising a first coupling portion at a distal end; and a second coupling portion at a proximal end, wherein the first coupling portion comprises a first upward-facing well configured to receive a leash, and the second coupling portion comprises a second downward-facing well configured to receive a belt or a clothing portion of a person.

In some embodiments, a present apparatus allows for a person to walk a dog, or multiple dogs, “hands-free”. In some embodiments, a present apparatus allows for a person to quickly release it from the person, and/or to quickly release a leash from the apparatus.

### BRIEF DESCRIPTION OF THE DRAWINGS

This disclosure is illustrated by way of example and not by way of limitation in the accompanying figures. For simplicity and clarity of illustration, features illustrated in the figures are not necessarily drawn to scale. For example, the dimensions of some features may be exaggerated relative to other features for clarity. Further, where considered appropriate, reference labels have been repeated among the figures to indicate corresponding or analogous elements.

FIG. 1 provides views of a hands-free leash assembly, according to some embodiments.

### DETAILED DESCRIPTION

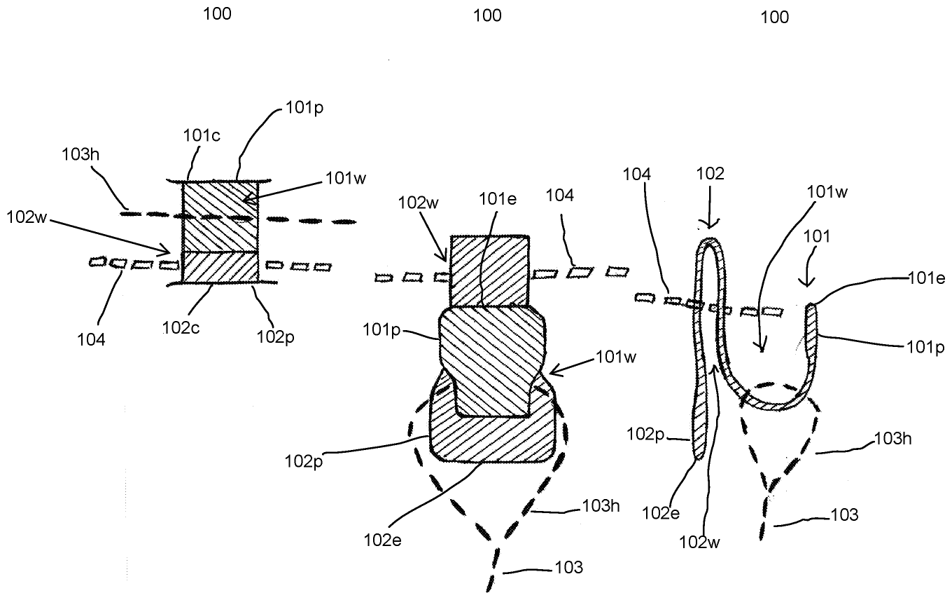

FIG. 1 provides top, front, and side views (left-to-right) of hands-free leash assembly 100, respectively, according to some embodiments. Assembly 100 comprises first coupling portion 101 at a distal end, and second coupling portion 102 at a proximal end. First coupling portion 101 is configured to receive leash handle 103h of leash 103 in first well 101w. Second coupling portion 102 comprises second well 102w, configured to receive for example belt 104, or a pants waist of a dog walker. Distal end coupling portion 101 comprises upward projection 101p. As shown in front view FIG. 1B, projection 101p comprises a greater width at upper distal end 101e than at a low point of well 101w. As shown in side view FIG. 1C, projection 101p comprises a greater thickness than a low point of well 101w. Proximal end coupling portion 102 comprises downward projection 102p. As shown in front view FIG. 1B, downward projection 102p comprises a greater width at lower proximal end 102e than at a high point of well 102w. As shown in side view FIG. 1C, projection 102p comprises a greater thickness than a high point of well 102w. Assembly 100 is about 2.7 inches at a widest point from a front view, about 2.1 inches at a widest point from a side view, and about 1.7 inches at a widest point from a top view, from proximal end to distal end. Assembly 100 is about 3.5 inches high in a front view. Proximal end 102 comprises inward curved surface 102c, configured to approximate a curve of a person's waist or belt. Distal end 101 comprises outward curved surface 101c.

Handle 103h of leash 103 is shown coupled to distal end coupling portion 101. Leash handle 103h is shown “coupled to” or inserted into well 101w. Assembly 100 is configured to slide over and thereby coupled to a person's pants waist or belt, as shown belt 104 is “coupled to” or inserted into proximal well 102w. Apparatus 100 is configured to couple to a person's pants, shorts, or belt, and to couple to a dog leash, allowing one to walk a dog “hands-free”. Apparatus 100 is also configured to allow for one to quickly and easily “decouple” leash 103, by simply lifting leash handle 103h about top distal end 101e. A person may wish to quickly decouple a leash from apparatus 100 for example if a dog is attempting to chase another animal.

A term “companion” animal, may generally mean a pet dog, police dog, or a hunting dog, and may also include other animals that may require a tether to a person, for instance, a pig, skunk, ferret, cat, goat, sheep, etc.

A term “belt or clothing portion” of a person may refer to any type of belt and to any type of a waist configured to cloth a person, for instance a waist of pants, shorts, pajamas, and the like. The term also includes pockets or any other features of clothing that a present apparatus may couple to. In some embodiments, a present apparatus may be configured such that a leash may be quickly decoupled, or comprise a “quick release” function. A person may need or want to quickly release a leash under certain circumstances. In some embodiments, a present apparatus may be configured such that the apparatus itself may be quickly decoupled from a person's belt or clothing.

A present apparatus may comprise for example a metal, metal alloy, or a thermoplastic. Thermoplastics include engineering thermoplastic (e.g. glass-filled PPS or PPA). Engineering thermoplastics include for example polyamides, polyesters, polycarbonates, acrylonitrile-butadiene-styrene (ABS), polysulfones (PSU), polyethersulfones (PESU), cyclic olefin copolymer (COC), acrylonitrile-styrene-acrylate (ASA), polyphenylene oxides (PPO), polyphenylene sulfides (PPS), polyphenylenesulfones (PPSU), polyether ether ketones (PEEK), polyethylenimine (PEI), polyphthalamides (PPA), polyacetals, copolymers thereof, and blends thereof. Polyamides include nylon and polyphthalamide (PPA). Polyacetals include polyoxymethylene (POM). In some embodiments, a thermoplastic polymer may comprise a glass-filled thermoplastic, for example a glass-filled polyamide. A thermoplastic may be prepared via a molding process, for example injection molding. A present apparatus may be a single unitary part. A present apparatus may comprise an elastomer or a rubber.

Disclosed is an apparatus for walking a companion animal, the apparatus comprising a first coupling portion at a distal end; and a second coupling portion at a proximal end, wherein the first coupling portion comprises a first upward-facing well configured to receive a leash, and the second coupling portion comprises a second downward-facing well configured to receive a belt or a clothing portion of a person. The apparatus may be configured for the person to walk the companion animal “hands-free”. The apparatus may be configured such that the first coupling portion is configured for quick release of the leash. The apparatus may be configured such that the second coupling portion is configured for quick release from the clothing portion. In some embodiments, a term “configured to receive a leash” may mean “configured to receive a leash handle”. In other embodiments, an apparatus may be configured to receive another portion of a leash.

As discussed, the apparatus may comprise a metal or a thermoplastic, for instance both a metal and a thermoplastic. Thermoplastics include engineering thermoplastics. In some embodiments, an apparatus may comprise a height in a front view of from any of about 2.0 inches, about 2.5 inches, about 3.0 inches, about 3.5 inches, about 4.0 inches, about 4.5 inches, about 5.0 inches, about 5.5 inches, about 6.0 inches, or about 6.5 inches, to any of about 7.0 inches, about 7.5 inches, about 8.0 inches, about 8.5 inches, about 9.0 inches, or more.

In some embodiments, an apparatus may comprise a largest width in a front view of from any of about 1.0 inches, about 1.4 inches, about 1.8 inches, about 2.2 inches, about 2.6 inches, about 3.0 inches, about 3.4 inches, or about 3.8 inches, to any of about 4.2 inches, about 4.6 inches, about 5.0 inches, about 5.4 inches, about 5.7 inches, about 6.0 inches, or more.

In some embodiments, an apparatus may comprise a largest width in a side view of from about 1.0 inches, about 1.3 inches, about 1.6 inches, about 1.9 inches, about 2.2 inches, about 2.5 inches, about 2.8 inches, about 3.1 inches, or about 3.4 inches, to any of about 3.7 inches, about 4.0 inches, about 4.3 inches, about 4.7 inches, about 5.0 inches, or more.

An apparatus first coupling portion may comprise an upward projection positioned at the apparatus distal end. An upward projection may be wider in a front view at the distal end than at a first well low point. An upward projection may comprise a greater thickness in a side view than at a first well low point.

An apparatus second coupling portion may comprise a downward projection positioned at the apparatus proximal end. A downward projection may be wider in a front view at the proximal end than at a second well high point. A downward projection may comprise a greater thickness in a side view than at a second well high point.

In some embodiments, an apparatus proximal end may comprise an inwardly curved portion. In some embodiments, an apparatus distal end may comprise an outwardly curved portion.

In some embodiments, a present apparatus may be flexible, rigid, or partly-flexible. An apparatus may comprise one or more flexible portions, and one or more rigid portions.

Following are some non-limiting embodiments.

In a first embodiment, disclosed is an apparatus for walking a companion animal, the apparatus comprising a first coupling portion at a distal end; and a second coupling portion at a proximal end, wherein the first coupling portion comprises a first upward-facing well configured to receive a leash, and the second coupling portion comprises a second downward-facing well configured to receive a belt and/or a clothing portion of a person.

In a second embodiment, disclosed is an apparatus according to embodiment 1, configured for the person to walk the companion animal hands-free. In a third embodiment, disclosed is an apparatus according to embodiments 1 or 2, wherein the first coupling portion is configured for quick release of the leash. In a fourth embodiment, disclosed is an apparatus according to any of the preceding embodiments, wherein the second coupling portion is configured for quick release from the clothing portion.

In a fifth embodiment, disclosed is an apparatus according to any of the preceding embodiments, wherein the apparatus comprises a metal or a thermoplastic. In a sixth embodiment, disclosed is an apparatus according to any of the preceding embodiments, wherein the apparatus comprises an engineering thermoplastic.

In a seventh embodiment, disclosed is an apparatus according to any of the preceding embodiments, comprising a height in a front view of from about 2 inches to about 9 inches. In an eighth embodiment, disclosed is an apparatus according to any of the preceding embodiments, comprising a height in a front view of from about 2 inches to about 6 inches. In a ninth embodiment, disclosed is an apparatus according to any of the preceding embodiments, comprising a largest width in a front view of from about 1 inch to about 6 inches. In a tenth embodiment, disclosed is an apparatus according to any of the preceding embodiments, comprising a largest width in a front view of from about 2 inches to about 4 inches. In an eleventh embodiment, disclosed is an apparatus according to any of the preceding embodiments, comprising a largest width in a side view of from about 1 inch to about 5 inches. In a twelfth embodiment, disclosed is an apparatus according to any of the preceding embodiments, comprising a largest width in a side view of from about 1 inch to about 4 inches.

In a thirteenth embodiment, disclosed is an apparatus according to any of the preceding embodiments, wherein the first coupling portion comprises an upward projection positioned at the apparatus distal end. In a fourteenth embodiment, disclosed is an apparatus according to embodiment 13, wherein the upward projection is wider in a front view at the distal end than at a first well low point. In a fifteenth embodiment, disclosed is an apparatus according to embodiments 13 or 14, wherein the upward projection comprises a greater thickness in a side view than at a first well low point.

In a sixteenth embodiment, disclosed is an apparatus according to any of the preceding embodiments, wherein the second coupling portion comprises a downward projection positioned at the apparatus proximal end. In a seventeenth embodiment, disclosed is an apparatus according to embodiment 16, wherein the downward projection is wider in a front view at the proximal end than at a second well high point. In an eighteenth embodiment, disclosed is an apparatus according to embodiments 16 or 17, wherein the downward projection comprises a greater thickness in a side view than at a second well high point.

In a nineteenth embodiment, disclosed is an apparatus according to any of the preceding embodiments, wherein the proximal end comprises an inwardly curved portion. In a twentieth embodiment, disclosed is an apparatus according to any of the preceding embodiments, wherein the distal end comprises an outwardly curved portion.

The terms “coupled” or “connected” may mean that an element is “attached to” or “associated with” another element. Coupled or connected may mean directly coupled or coupled through one or more other elements. An element may be coupled to an element through two or more other elements in a sequential manner or a non-sequential manner. The term “via” in reference to “via an element” may mean “through” or “by” an element. Coupled or connected or “associated with” may also mean elements not directly or indirectly attached, but that they “go together” in that one may function together with the other.

The term “towards” in reference to a of point of attachment, may mean at exactly that location or point or, alternatively, may mean closer to that point than to another distinct point, for example “towards a center” means closer to a center than to an edge.

The term “like” means similar and not necessarily exactly like. For instance “ring-like” means generally shaped like a ring, but not necessarily perfectly circular.

The articles “a” and “an” herein refer to one or to more than one (e.g. at least one) of the grammatical object. Any ranges cited herein are inclusive. The term “about” used throughout is used to describe and account for small fluctuations. For instance, “about” may mean the numeric value may be modified by ±0.05%, ±0.1%, ±0.2%, ±0.3%, ±0.4%, ±0.5%, ±1%, ±2%, ±3%, ±4%, ±5%, ±6%, ±7%, ±8%, ±9%, or ±10%. All numeric values are modified by the term “about” whether or not explicitly indicated. Numeric values modified by the term “about” include the specific identified value. For example “about 5.0” includes 5.0.

The term “substantially” is similar to “about” in that the defined term may vary from for example by ±0.05%, ±0.1%, ±0.2%, ±0.3%, ±0.4%, ±0.5%, ±1%, ±2%, ±3%, ±4%, ±5%, ±6%, ±7%, ±8%, ±9%, or ±10% of the definition; for example the term “substantially perpendicular” may mean the 90° perpendicular angle may mean “about 90°”. The term “generally” may be equivalent to “substantially”.

Features described in connection with one embodiment of the disclosure may be used in conjunction with other embodiments, even if not explicitly stated.

Embodiments of the disclosure include any and all parts and/or portions of the embodiments, claims, description and figures. Embodiments of the disclosure also include any and all combinations and/or sub-combinations of embodiments.

1. An apparatus for walking a companion animal, the apparatus comprising
a first coupling portion at a distal end; and
a second coupling portion at a proximal end,
wherein
the first coupling portion comprises a first upward-facing well configured to receive a leash, and
the second coupling portion comprises a second downward-facing well configured to receive a belt and/or a clothing portion of a person.

2. The apparatus according to claim 1, configured for the person to walk the companion animal hands-free.

3. The apparatus according to claim 1, wherein the first coupling portion is configured for quick release of the leash.

4. The apparatus according to claim 1, wherein the second coupling portion is configured for quick release from the clothing portion.

5. The apparatus according to claim 1, wherein the apparatus comprises a metal or a thermoplastic.

6. The apparatus according to claim 1, wherein the apparatus comprises an engineering thermoplastic.

7. The apparatus according to claim 1, comprising a height in a front view of from about 2 inches to about 9 inches.

8. The apparatus according to claim 1, comprising a height in a front view of from about 2 inches to about 6 inches.

9. The apparatus according to claim 1, comprising a largest width in a front view of from about 1 inch to about 6 inches.

10. The apparatus according to claim 1, comprising a largest width in a front view of from about 2 inches to about 4 inches.

11. The apparatus according to claim 1, comprising a largest width in a side view of from about 1 inch to about 5 inches.

12. The apparatus according to claim 1, comprising a largest width in a side view of from about 1 inch to about 4 inches.

13. The apparatus according to claim 1, wherein the first coupling portion comprises an upward projection positioned at the apparatus distal end.

14. The apparatus according to claim 13, wherein the upward projection is wider in a front view at the distal end than at a first well low point.

15. The apparatus according to claim 13, wherein the upward projection comprises a greater thickness in a side view than at a first well low point.

16. The apparatus according to claim 1, wherein the second coupling portion comprises a downward projection positioned at the apparatus proximal end.

17. The apparatus according to claim 16, wherein the downward projection is wider in a front view at the proximal end than at a second well high point.

18. The apparatus according to claim 16, wherein the downward projection comprises a greater thickness in a side view than at a second well high point.

19. The apparatus according to claim 1, wherein the proximal end comprises an inwardly curved portion.

20. The apparatus according to claim 1, wherein the distal end comprises an outwardly curved portion.
